(19) United States
(12) Patent Application Publication
(10) Pub. No.: US 2006/0110502 A1
(43) Pub. Date: May 25, 2006

(54) Sausage product and corresponding sausage casing

(76) Inventors: Christian Auf der Heide, Osnabruck (DE); Dirk Auf der Heide, Alfhausen (DE); Olaf Gauger, Nackenheim (DE)

Correspondence Address: GUDRUN E. HUCKETT DRAUDT, LONSSTR. 53, WUPPERTAL, 42289, DE

(21) Appl. No.: 10/550,144

(22) PCT Filed: Mar. 22, 2004
(86) PCT No.: PCT/EP04/03008

§ 371 Date: Nov. 18, 2005

(30) Foreign Application Priority Data
Mar. 22, 2003 (DE) 103 12 890.5
Dec. 17, 2003 (DE) 103 59 111.7

(51) Int. Cl. A21D 13/00

(52) U.S. Cl. 426/138

(57) ABSTRACT

A sausage product has a sausage casing closed at the ends and a sausage contents contained in the sausage casing. The sausage casing has an opening element that, when actuated, opens the sausage casing in the area of the opening element. The opening element is arranged such on the sausage casing that the sausage casing is opened by the opening element in a direction substantially transverse to a longitudinal sausage axis of the sausage product.

The invention relates to a sausage product comprising a sausage casing, closed at its ends and containing sausage contents, as well as a corresponding sausage casing. Independent of possible food law labeling, the term sausage product in the context of the invention is not to be understood to mean exclusively meat-containing products but all products produced in a corresponding sausage shape.

In the case of conventional sausage products, the sausage contents is filled into a sausage casing and the sausage casing that is either a natural sausage casing or an artificial foodstuff casing is closed at its ends usually by a clip, respectively, or by tying a knot or the like. For opening the sausage product or the sausage, an aid, usually a knife or scissors, must be used in order to cut open the sausage casing or to cut off a sausage end directly. Since the employed sausage casings should not become accidentally damaged, they are made to be very strong. In particular, artificial sausage casings are subject during processing for manufacturing sausage products to high mechanical requirements and are designed to ensure maximum protection of the sausage contents. They are therefore designed to have high mechanical and physical strength so that very sharp and pointed knives are to be used for separating and opening the sausage casing; for this purpose, the customarily employed silverware is not sufficient. Accordingly, there is a risk of injury in particular in the case of children and elderly consumers. Moreover, sausages cannot be consumed on the go, for example, when there is no suitable opening aid at hand.

It is an object of the present intention to provide a sausage or a corresponding sausage casing that can be opened in a simple way without additional opening aids. This object is solved according to the present intention by a sausage product having the features of claim 1 or by a corresponding sausage casing.

By providing the sausage casing itself with an opening element whose actuation enables a targeted opening of the sausage casing in the area of the opening element, additional opening aids, in particular, knives, are no longer needed. In this connection, the sausage casing with the opening element must be completely closed before opening because the sausage contents can easily spoil. Well-known so-called tear strips, for example, those on chewing gum packages, are not suitable because the packaging is already provided with an opening, even though a small one, in the area of the beginning of the strip.

Preferably, the opening element has a free grip area and a tearing area that is fixedly connected to the sausage casing. The free grip area serves in this connection for providing easy handling and the tearing area entrains a portion of the sausage casing when opening the sausage casing. It is specially advantageous to employ materials, so-called isotropic materials, for the sausage casing that have an excellent tear-off propagation in the transverse and longitudinal directions. In this connection, when opening by means of the opening element the sausage casing can be removed spirally in strips so that always only so much sausage contents is exposed as is to be consumed.

For simplifying the opening action, in order not to expose the entire sausage contents at once, the opening element is arranged preferably such on the sausage casing that its actuation effects opening of the sausage casing substantially transversely to a longitudinal axis of the sausage. The longitudinal sausage axis is to be understood preferably as the elongate extension axis of the sausage, usually also the filling direction of the sausage casing, independent of whether it is straight or bent as in the case of a natural sausage casing.

Expediently, the opening element is to be provided near the end of the sausage so that upon opening there are not several portions of the sausage exposed in addition to the end piece that is to be consumed immediately. In order to prevent that the opening element is ripped off entirely by accident, it should be connected fixedly to the sausage casing. This can be realized, in particular, by gluing or welding but also by other joining techniques.

Further advantages and details result from the dependent claims and the embodiments illustrated in the drawing that will be explained in the following. It is shown in:

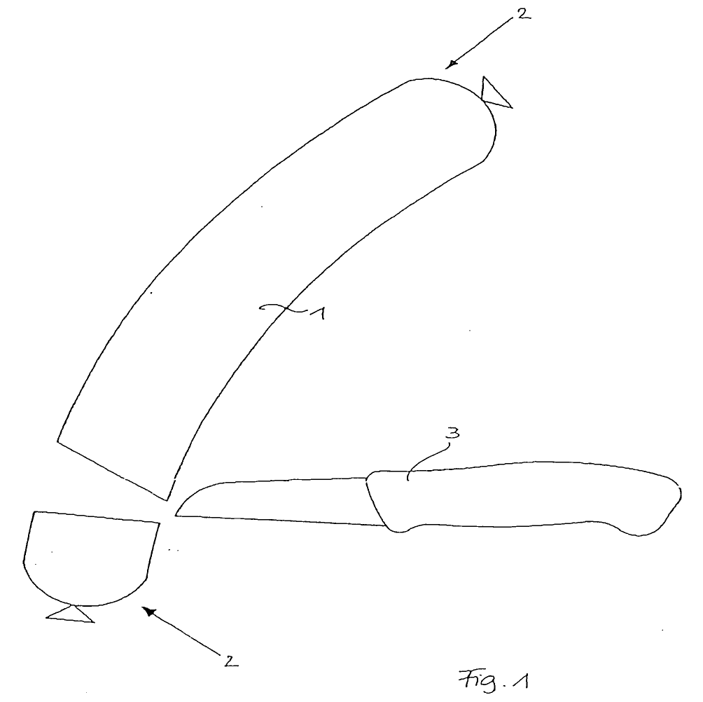

FIG. 1 opening of a conventional sausage product;

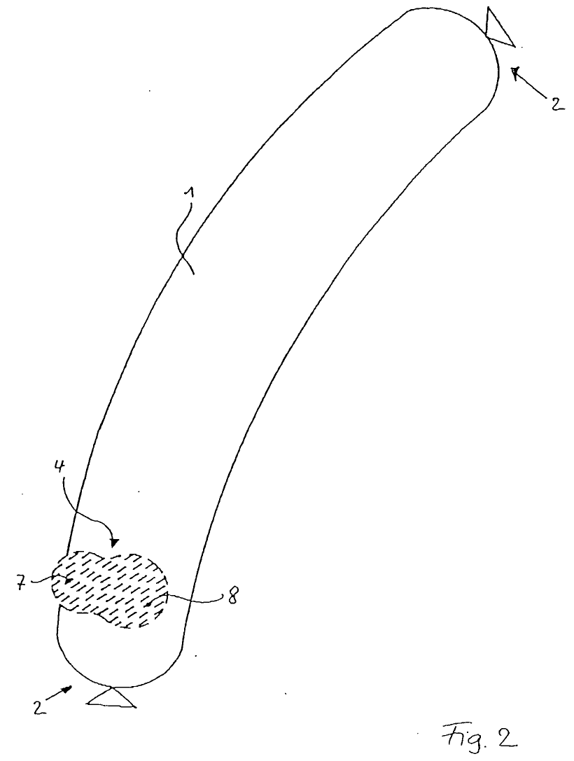

FIG. 2 a sausage product according to the invention with opening element;

FIG. 3 the article of FIG. 2 without the opening element;

FIG. 4 the article of FIG. 2 while being opened;

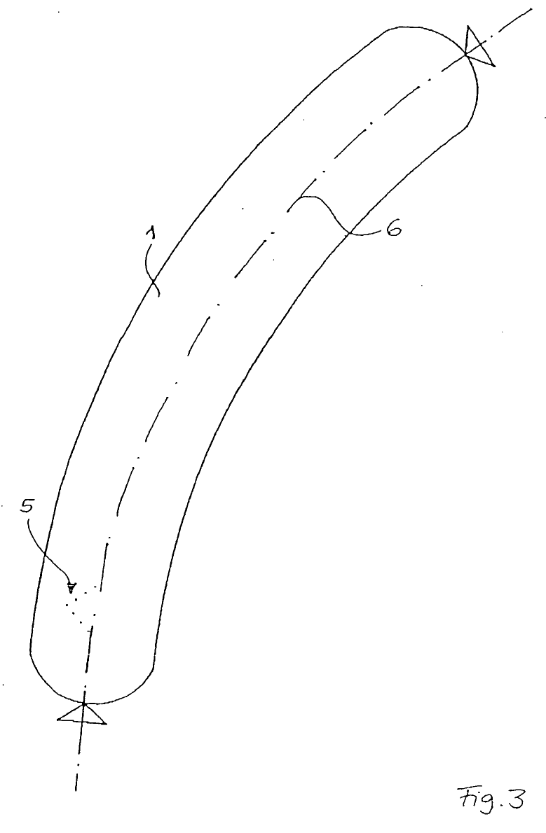

FIG. 5 the bottom side of the opening element of FIG. 2;

FIG. 6 an opening element of a different embodiment;

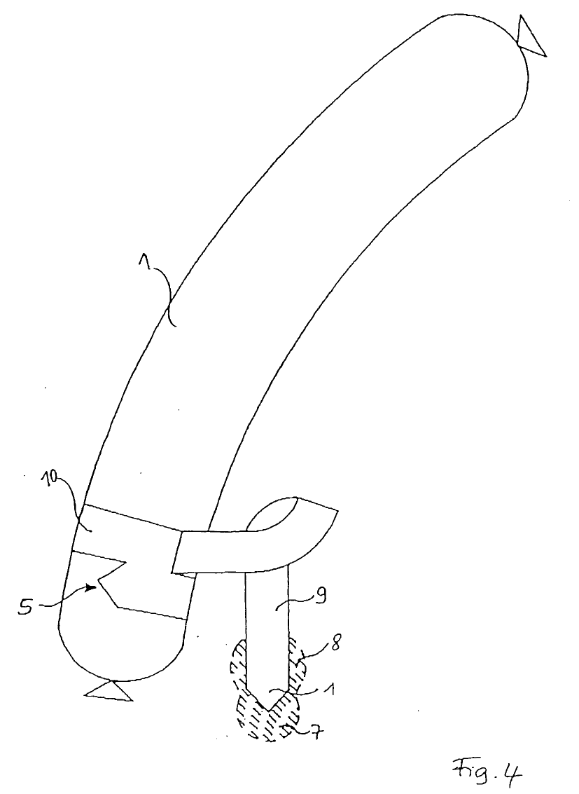

FIG. 7 an opening element in yet another embodiment;

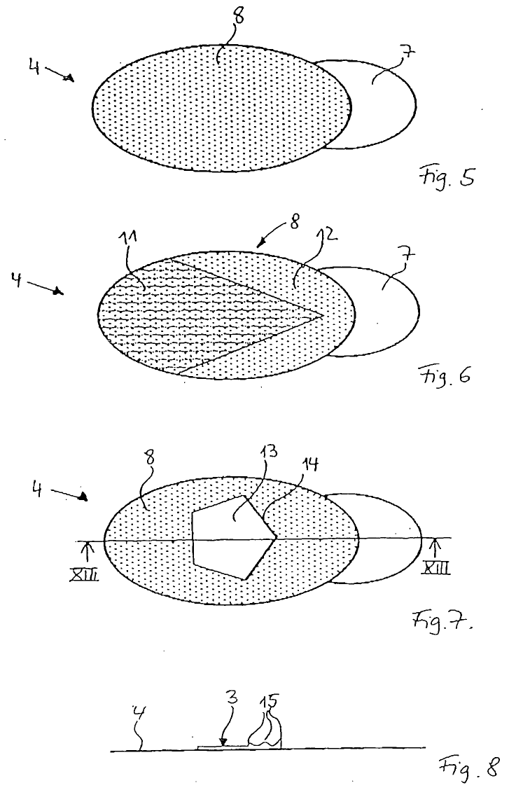

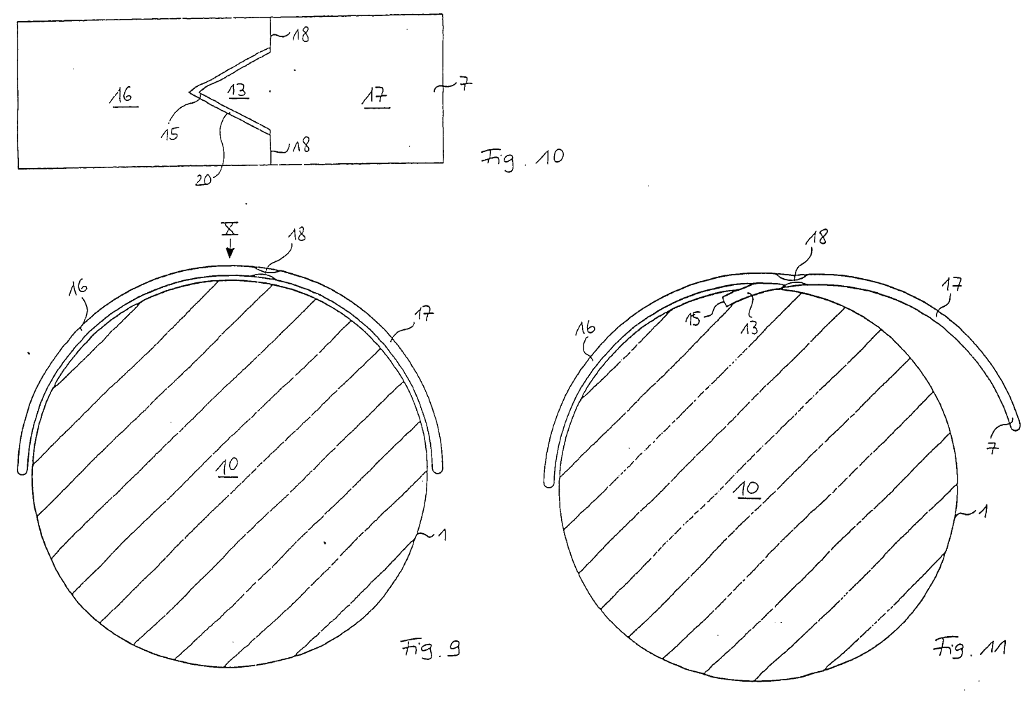

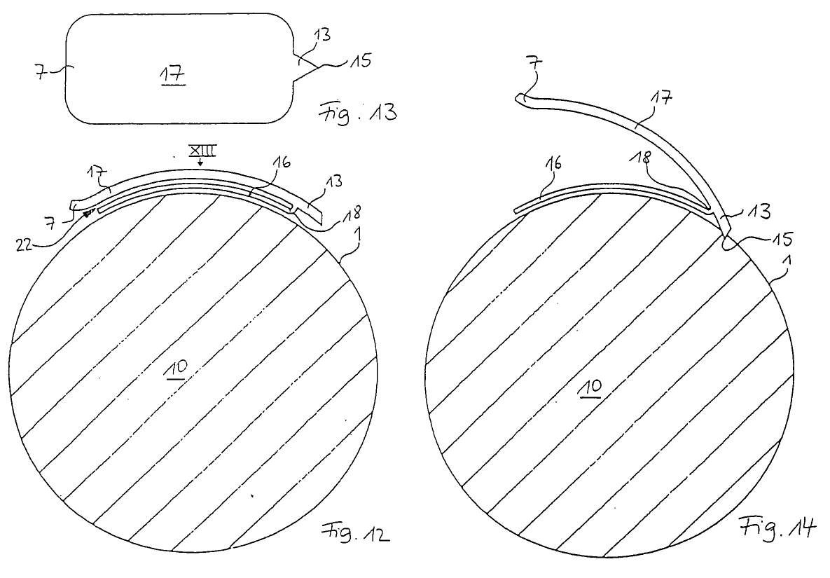

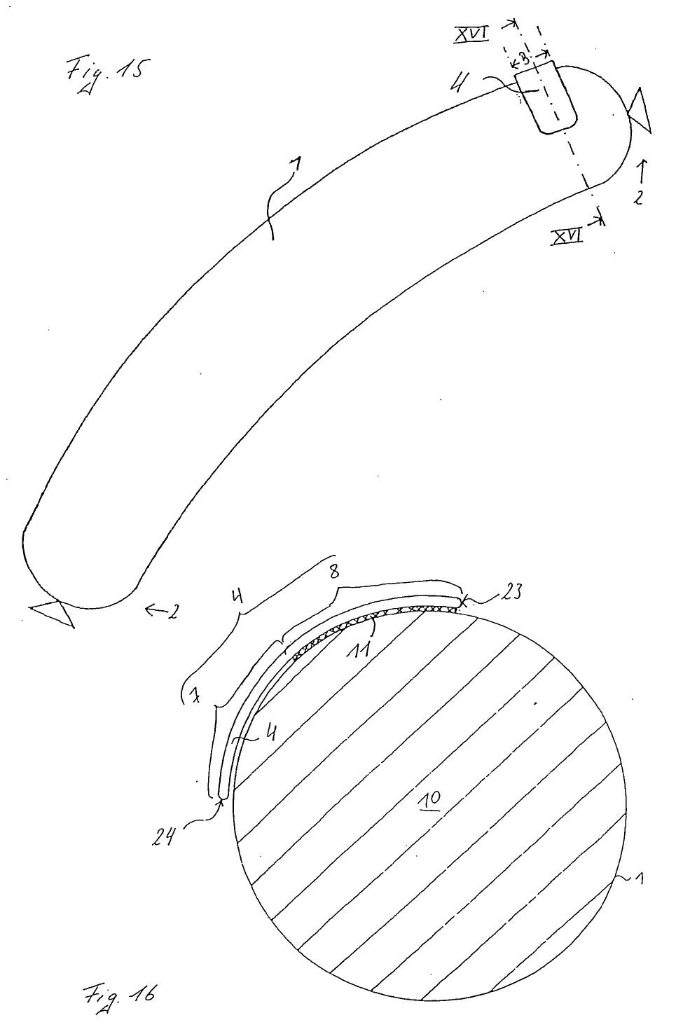

FIG. 8 a section of the opening element of FIG. 7 in the direction VIII-VIII;

FIG. 9 a sausage in section with a different opening element;

FIG. 10 a plan view onto the opening element of FIG. 9 in the direction X;

FIG. 11 the article of FIG. 9 while being opened;

FIG. 12 another embodiment of the article of FIG. 9;

FIG. 13 a plan view onto the opening element of FIG. 12 in the direction XIII;

FIG. 14 the article of FIG. 12 while being opened;

FIG. 15 a sausage product according to the invention with a different opening element; and

FIG. 16 a section of the opening element of FIG. 15 in the direction XVI-XVI.

The sausage illustrated in FIG. 1 is a conventional sausage product with a sausage casing 1 into which sausage contents has been filled. Usually, the sausage casing 1 is originally a tube that is closed at both ends 2 with a clip that is not illustrated. For opening a conventional sausage, a knife 3 is usually employed, as illustrated in FIG. 1, with which one end of the sausage is cut off.

FIG. 2 shows a sausage according to the invention whose sausage casing 1 has an opening element 4 that is arranged as closely as possible next to one sausage end 2. The opening element is embodied like a pull tab and is connected to the sausage casing 1, in particular, by gluing, possibly also by e.g. welding. In one embodiment illustrated in particular in FIG. 3, the sausage casing 1 is pre-damaged in the area of the opening element, not illustrated in FIG. 3, at the position identified at 5. As illustrated, this pre-damage 5 is configured preferably like an arrow head, wherein the arrow head extends transversely to the longitudinal axis 6 of the sausage so that tearing of the sausage casing 1 during the opening action is realized also in the direction transverse to the longitudinal axis 6. The pre-damage 5 can be a weakened portion, for example, by reduction of wall thickness, of the sausage casing 1 but also a complete perforation of the sausage casing 1, i.e., a dotted separation or a cut. Particularly in the case of a pre-damage 5 with separation of the sausage casing 1, it must be ensured that the sausage contents does not spoil. For this purpose, the opening element 4 can be arranged such across the pre-damage, particularly by gluing, that it completely covers and closes the pre-damage 5.

FIG. 4 shows the opening process of the sausage illustrated in FIGS. 2 and 3 wherein a grip area 7 of the opening element 4 has been pulled. In doing so, a tearing area 8 fixedly connected to the sausage casing 1 will tear open the sausage casing 1 at the pre-damage 5. By means of the opening element 4, a strip 9 of the sausage casing 1 can then be torn off having a width that matches essentially the width of pre-damage 5 and can be peeled off the sausage spirally so that as much sausage contents 10 as desired is exposed.

FIG. 5 shows the bottom side of the opening element 4 of FIGS. 2 and 4 that is facing the sausage casing. In this connection, the tearing area 8 is coated with an adhesive and the grip area 7 is free and not directly connected to the sausage casing so that the opening element 4 can be lifted off by it. The grip area 7 can also be provided with an easily releasable adhesion action relative to the sausage casing 1.

FIGS. 6 through 14 illustrate other embodiments of the opening element 4. These embodiments can be used also without a pre-damage of the sausage casing 1.

The opening element 4 of FIG. 6 is designed such that a connection to the sausage casing is realized in a way that favors a targeted damaging of the sausage casing. For this purpose, an area of strongly adhering adhesive 11 is applied in the tearing area 8 and tapers pointedly toward the grip area 7. Its adhesive force on the sausage casing is so strong that it surpasses the tearing resistance of the sausage casing. Preferably, the other tearing area 8 as illustrated in FIG. 6 can be provided with an adhesive 12 of reduced adhesive force 12 that secures the opening element 4 as a whole on the sausage casing.

In the embodiment according to the invention illustrated in FIGS. 7 through 14, the opening element 4 comprises a damaging tool 13. As illustrated in the embodiment according to FIG. 7 and 8, it is provided at its edges facing the grip area 7 with sharp edges, in particular, with individual tips 15 that can penetrate the sausage casing. Preferably, the damaging tool 13 is provided at the bottom side of the opening element 4 facing the sausage casing. However, it can also be provided on its top side wherein the edges or tips are then configured to be so sharp that they are able to penetrate also the opening element 4 itself. In a particularly simple and inexpensive way, the damaging tool 13 can be produced especially as an injection-molded or stamped plastic piece or, for example, a sheet metal piece with an edge that is angled in the direction toward the sausage casing.

In the manufacturing process, the opening element 4 of FIG. 7 can be applied onto the sausage casing 1 filled with sausage contents 10 such that the resulting damage of the sausage casing 1 by impressing the damaging tool 13 of the opening element 4 is immediately hygienically closed across the remaining tearing area 8 without this causing hygienic impairments. However, it is also possible to connect the opening element 4 without applying pressure onto the damaging tool 13 such to the sausage casing 1 that the sausage casing 1 remains initially intact. In this way, only upon opening the sausage by applying pressure onto an area of the opening element 4, in which the damaging tool 13 is arranged and that is preferably marked accordingly, the sausage casing 1 is damaged in a targeted way and subsequently torn open by the opening element 4.

FIGS. 9 through 14 show additional products with opening elements 4 with damaging tools 13 in which the opening element 4 is at least partially embodied as a bending-resistant lever. In FIGS. 9 through 11, the opening element 4 surrounds the sausage like a partial ring. A portion 16 is fixedly connected to the sausage casing 1. A movable portion 17 is preferably pivotably joined to this portion 16. By lifting the movable portion 17 at its end that is embodied as a grip area 7, the spike-shaped damaging tool 13 penetrates the sausage casing 1 as illustrated in FIG. 11 and opens it.

FIGS. 12 through 14 show another embodiment variant but with a similar function as disclosed in connection with FIGS. 9 through 11. In both cases the opening element is preferably a unitary part, in particular, a plastic part. In this connection, the movability or hinge action of the movable portion 17 can be achieved preferably by a film hinge 18.

In both embodiments, the movable portion 17 can be secured against accidental actuation. This can be realized, for example, in that the grip area 7 of the movable portion 17 is secured by means of a lightly adhering adhesive on the sausage casing 1 or relative to the remaining part of the opening element 4. Also, the opening element 4 can be provided with a kind of seal that serves at the same time as a fixation and indicates that the opening element 4 has not been actuated. Such a seal could be formed, in particular, in the case of a plastic element, by thin stays that are broken upon actuation. These stays in the embodiment according to FIG. 10 can be provided in the gap identified at 20 between the damaging tool 13 and the fixed portion 16 of the opening element 4. In the case of the opening tool of FIG. 12 the connection or the seal embodied as a rated break point is provided preferably at the rear end 22 between the fixed portion 16 and the movable portion 17.

FIGS. 15 and 16 show another embodiment of the opening element 4. It is preferably of a monolithic configuration and is embodied substantially in a bending-resistant way. The grip area 7 is rigidly connected to the tearing area 8 and forms therewith a lever. In this connection, the tearing area 8 functions as a lever in addition to the function of tearing open the sausage casing. The tearing area 8, in contrast to the grip area 7, is connected to the sausage casing 1 by means of a strongly adhering adhesive 11. Because of the lever action a significantly reduced force expenditure is required for opening the sausage casing 1 by means of the opening element 4.

The end 23 of the opening element 4 opposite the grip area 7 is rounded. Upon actuation of the opening element 4, this rounded end area 23 functions as a contact surface on the sausage casing 1. As a result of the rounded portion the sausage casing does not tear in this area but tears between the grip area 7 and the tearing area 8. In this embodiment, a weakening of the sausage casing 1 in this area is possible by a pre-damage, a thinner material and the like, but this is not mandatory.

As illustrated in FIG. 16, the opening element 4 has a curvature that follows the contour of the sausage product and is substantially matched to the shape or caliber of the sausage product. In this way, accidental actuation of the opening element 4, for example, by getting caught on objects in the surroundings, is prevented. It is also possible in this way to package several such sausage products closer together.

The opening element 4 is preferably essentially rectangular with rounded corners. Depending on the shape of the sausage product and the employed material for the sausage casing 1 or the opening element 4, a trapezoidal or triangular configuration of the opening elements 4, each with rounded corners, can also be expedient in order to obtain a greater width of the end area 23 serving as a contact surface relative to the width of the leading end area 24 of the opening element for the purpose of an optimal force distribution.

In order to be able to provide a sufficient contact force upon actuation of the opening element 4 and in order to prevent penetration of the tearing area 8 into the sausage product, the width B of the opening element 4 on the end of the tearing area 8 opposite the grip area 7 is advantageously greater than 5 mm and preferably 10 to 30 mm. The softer the sausage material of the sausage product, the greater the contact surface or the width B should be. Also, the length of the tearing area 8 is advantageously longer than 4 mm and is preferably 5 to 15 mm. In order to obtain a sufficient lever action, the ratio of length of the tearing area 8 to the grip area 7 is preferably smaller or equal to 3 and preferably 0.5 to 2.

As a whole, the sausage product according to the invention is characterized by easy and safe handling.

What is claimed is:

1-26. (canceled)

27. A sausage product comprising:
a sausage casing closed at opposed ends;
sausage contents contained in the sausage casing;
the sausage casing having an opening element that, when actuated, opens the sausage casing in the area of the opening element.

28. The sausage product according to claim 27, wherein the sausage casing is comprised of a material adapted to be torn in all directions.

29. The sausage product according to claim 27, wherein the opening element is arranged such on the sausage casing that the sausage casing is opened by the opening element in a direction substantially transverse to a longitudinal sausage axis of the sausage product.

30. The sausage product according to claim 27, wherein the opening element is arranged near one of the opposed ends.

31. The sausage product according to claim 27, wherein the opening element is fixedly connected to the sausage casing by gluing or welding.

32. The sausage product according to claim 27, wherein the sausage casing has a pre-damage in the area of the opening element.

33. The sausage product according to claim 32, wherein the pre-damage is a perforation that is substantially arrowhead-shaped.

34. The sausage product according to claim 32, wherein the pre-damage is closed by the opening element.

35. The sausage product according to claim 27, wherein the opening element comprises a free grip area and a tearing area, wherein the tearing area is fixedly connected by a connecting means to the sausage casing.

36. The sausage product according to claim 35, wherein the connecting means is an adhesive that is coated on a side of the tearing area facing the sausage casing.

37. The sausage product according to claim 35, wherein the connecting means has a shape that assists in a targeted damaging and opening of the sausage casing.

38. The sausage product according to claim 35, wherein the connecting means is shaped to taper pointedly toward the grip area.

39. The sausage product according to claim 35, wherein the connecting means is designed to be stronger than an initial tearing resistance of the sausage casing.

40. The sausage product according to claim 35, wherein the grip area is rigidly connected to the tearing area.

41. The sausage product according to claim 27, wherein the opening element comprises a damaging tool.

42. The sausage product according to claim 41, wherein the opening element has a bottom side that is facing the sausage casing and wherein the damaging tool is arranged on the bottom side.

43. The sausage product according to claim 41, wherein the damaging tool is at least partially sharp-edged; pointed; or at least partially sharp-edged and pointed.

44. The sausage product according to claim 41, wherein the damaging tool is comprised of a plastic part or a sheet metal part, wherein the plastic part or the sheet metal part has at least one edge that is angled in a direction toward the sausage casing.

45. The sausage product according to claim 41, wherein the opening element has a first portion fixedly connected to the sausage casing and a second portion comprising the damaging tool, wherein the second portion is movably connected to the first portion for actuating the damaging tool.

46. The sausage product according to claim 45, wherein the second portion is secured against accidental actuation.

47. The sausage product according to claim 45, wherein the first portion is a unitary part of the second portion.

48. The sausage product according to claim 27, wherein the opening element is a monolithic part and is substantially bending-resistant.

49. The sausage product according to claim 27, wherein the opening element has a curvature that follows substantially a contour of the sausage product and is substantially matched to the shape of the sausage product.

50. The sausage product according to claim 27, wherein the opening element has a blunt edge or is rounded in areas that contact the sausage casing during actuation of the opening element.

51. The sausage product according to claim 27, wherein the opening element is substantially rectangular with rounded corners.

52. A sausage casing for a sausage product according to claim 27.
